(19) United States
(12) Patent Application Publication
(10) Pub. No.: US 2015/0247418 A1
(43) Pub. Date: Sep. 3, 2015

(54) GAS TURBINE HAVING A HEAT FLOW SENSOR

(71) Applicant: SIEMENS AKTIENGESELLSCHAFT, München (DE)

(72) Inventors: Anand A. Kulkarni, Charlotte, NC (US); Stefan Lampenscherf, Poing (DE)

(73) Assignee: Siemens Aktiengesellschaft, Munich (DE)

(21) Appl. No.: 14/430,393

(22) PCT Filed: Sep. 26, 2013
(86) PCT No.: PCT/EP2013/070047

§ 371 Date: Mar. 23, 2015

(30) Foreign Application Priority Data
Sep. 27, 2012 (DE) 10 2012 217 535.0

(51) Int. Cl. F01D 21/00; G01K 13/00

(52) U.S. Cl. CPC F01D 21/003; G01K 13/00

(57) ABSTRACT

A gas turbine is provided having a heat flow sensor which is arranged on a surface of a component of the gas turbine and which is designed as a thermal element, wherein the heat flow sensor is a transverse thermoelectric element.

### CROSS REFERENCE TO RELATED APPLICATIONS

This application is the US National Stage of International Application No. PCT/EP2013/070047 filed Sep 26, 2013, and claims the benefit thereof. The International Application claims the benefit of German Application No. DE 102012217535.0 filed Sep 27, 2012. All of the applications are incorporated by reference herein in their entirety.

### FIELD OF INVENTION

The invention relates to a gas turbine having a heat flow sensor.

### BACKGROUND OF INVENTION

In order to increase the performance and energy efficiency of industrial gas turbines, ever higher combustion temperatures are being sought in the combustion space of such turbines. The resulting material stresses make it necessary to accurately monitor the operating parameters and the state of components of gas turbines.

In order to be able to meet the sometimes mutually conflicting requirements for energy efficiency, emission control and wear, it is in this case particularly important to monitor the temperatures of the gas turbine. In particular, wear processes such as oxidation and creep are thermally activated and, in general, exponentially temperature-dependent.

Because of the high temperatures in the regions to be monitored, stringent requirements are placed on the sensors used, particularly in respect of their long-term functional integrity per se.

Besides the temperatures, heat fluxes through the thermal barrier layer of turbine components also need to be monitored. To this end, it is known to embed stacks of thermoelements in the barrier layer. The heat flux through the barrier layer can then be deduced from the temperatures measured at different depths of the barrier layer.

Such heat flow sensors are, however, extremely elaborate in terms of production as well as electrical connection under operating conditions of a gas turbine.

### SUMMARY OF INVENTION

It is therefore an object of the present invention to provide a gas turbine according to the claims, which allows simple and reliable measurement of the heat flux.

This object is achieved by a gas turbine according to the claims.

Such a gas turbine comprises a heat flow sensor, which is arranged on a surface of a component of the gas turbine and is configured as a thermoelement.

According to aspects of the invention, the heat flow sensor is in this case a transverse thermoelectric element.

Transverse thermoelectric elements are based on the use of anisotropic thermoelectric materials, the Seebeck tensor of which has nonzero off-diagonal elements. This results in a voltage perpendicular to a temperature gradient acting on the thermoelectric element.

In this way, it is possible to detect the heat flow in the gas turbine with a single sensor, without complex arrangements, for example stacks of thermoelements being necessary.

According to another configuration of the invention, the heat flow sensor comprises monocrystalline zinc oxide. Zinc oxide has an intrinsic anisotropy in relation to its thermoelectric properties, can be applied by sputtering in monocrystalline form with a given axial inclination, and is stable under operating conditions of a gas turbine.

In order to be able to determine the desired heat flow from the thermovoltage, it is expedient to arrange the thermoelectric element in such a way that the crystallographic c axis of the zinc oxide is tilted relative to a surface normal of the surface of the component.

Advantageously, the heat flow sensor is arranged below a thermal barrier layer of the component, so that on the one hand it receives the protection of the barrier layer and on the other hand the heat flow through the barrier layer can be detected exactly.

It is furthermore expedient for an electrical insulator layer to be arranged between the heat flow sensor and the surface of the component, so that the heat flow sensor is not short-circuited by the conductive surface of the component.

In another configuration of the invention, connection leads for the heat flow sensor are arranged between the electrical insulator layer and the thermal barrier layer, so that the leads themselves are likewise protected by the barrier layer.

### BRIEF DESCRIPTION OF THE DRAWINGS

The invention and its embodiments will be explained in more detail below with the aid of the drawing, in which:

FIG. 1 shows a schematic representation of the functionality of a transverse thermoelectric sensor; and

FIG. 2 shows a schematic sectional representation through the application region of a heat flow sensor in an exemplary embodiment of a gas turbine according to the invention.

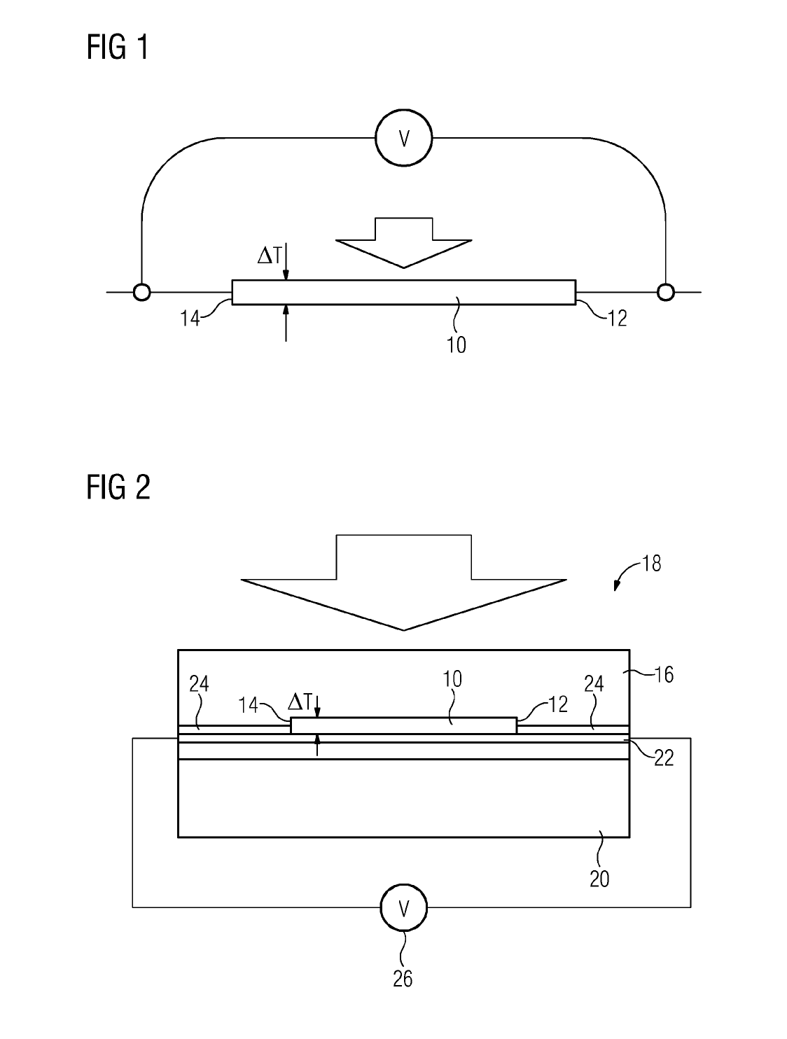

### DETAILED DESCRIPTION OF INVENTION

A transverse thermoelectric sensor 10 consists of a material with intrinsic anisotropy in relation to the thermoelectric effect, for example aluminum-doped monocrystalline zinc oxide, which is arranged in such a way that the crystallographic c axis is tilted relative to a heat flux to be measured. Along the heat flux through the sensor 10, a temperature gradient is set up, which in turn causes a potential difference perpendicular to the heat flux, so that a voltage which is proportional to the heat flow can be tapped at the side surfaces 12, 14 of the sensor 10.

In order to measure the heat flow through a thermal barrier layer 16 of a gas turbine 18, as represented as a detail in FIG. 2, an electrical insulator layer 22 is first applied onto a component 20—in particular a combustion chamber wall of the gas turbine. The sensor 10 is applied onto the insulator layer, for example by sputtering, and contacted on its side surfaces 12, 14 to electrical connection leads 24.

Lastly, the thermal barrier layer 16 is applied over the sensor 10 and the connection leads 24. This may, for example, be done by thermal spraying of a high temperature-stable ceramic.

During operation of the gas turbine, a heat flux is set up through the barrier layer 16, and therefore also through the sensor 10. Since the latter is arranged in such a way that the crystallographic c axis is tilted relative to the surface normal of the component 20, a potential difference is created between the side surfaces 12, 14, which can be tapped via the connection leads 24 and detected by a voltmeter 26.

From the detected transverse thermovoltage, while taking the geometry of the sensor 10 into account, the heat flux through the thermal barrier can be determined. The ratio between the length and thickness of the sensor 10 is particularly important in this case, since for a given heat flux the thermovoltage likewise increases with an increasing ratio.

Overall, a gas turbine is thus provided in which the heat flow through the thermal barrier layer can be monitored in a simple and reliable way, so that the barrier effect thereof can constantly be monitored reliably under operating conditions.

1. A gas turbine comprising:
a heat flow sensor, which is arranged on a surface of a component of the gas turbine and is configured as a thermoelement,
wherein the heat flow sensor is a transverse thermoelectric element.

2. The gas turbine as claimed in claim 1,
characterized in that wherein the heat flow sensor comprises monocrystalline zinc oxide.

3. The gas turbine as claimed in claim 2,
wherein a crystallographic c axis of the zinc oxide is tilted relative to a surface normal of the surface of the component.

4. The gas turbine as claimed in claim 1,
wherein the heat flow sensor is arranged below a thermal barrier layer of the component.

5. The gas turbine as claimed in claim 4,
further comprising an electrical insulator layer arranged between the heat flow sensor and the surface of the component.

6. The gas turbine as claimed in claim 5,
further comprising connection leads for the heat flow sensor arranged between the electrical insulator layer and the thermal barrier layer.
